(19) United States
(12) Patent Application Publication
(10) Pub. No.: US 2025/0060196 A1
(43) Pub. Date: Feb. 20, 2025

(54) COATING AND COMPOSITE MATERIALS FOR ENHANCING BALLISTIC PROTECTION

(71) Applicant: Gentex Corporation, Simpson, PA (US)

(72) Inventors: Bryton Farber, Greenfield Twp., PA (US); Russell Jon Caspe, South Abington Twp., PA (US); John Biteau, Clarks Summit, PA (US)

(73) Assignee: Gentex Corporation, Simpson, PA (US)

(21) Appl. No.: 18/721,603

(22) PCT Filed: Jan. 18, 2023
(86) PCT No.: PCT/US2023/060817

§ 371 Date: Jun. 18, 2024

Related U.S. Application Data
(60) Provisional application No. 63/300,804, filed on Jan. 19, 2022.

(51) Int. Cl. F41H 5/04; C09D 7/40; C09D 7/61; C09D 179/08

(52) U.S. Cl. CPC F41H 5/0492; C09D 7/61; C09D 7/69; C09D 7/70; C09D 179/08; F41H 5/0428

(57) ABSTRACT

A coating material includes a polymer binder, and particles having a hardness of at least 10 GPa and mixed with the polymer binder. The particles have a nominal diameter less than 1 millimeter and are suspended in the coating material prior to application to a surface. The coating material can be applied to a surface of a substrate, whether it is planar or non-planar. The coating material can also be applied uniformly or non-uniformly across the surface when it is desired. The coating material can further be incorporated in the ballistic core stack of a ballistic protection article. The coating material enhances the performance of the article against high-velocity ballistic threats or the like, using the same or similar defeat principles as thick ceramic plates/tiles.

### CROSS-REFERENCE TO RELATED APPLICATION

The present application claims priority to U.S. Provisional Patent Application No. 63/300,804, entitled “Coating and Composite Materials for Enhancing Ballistic Protection”, filed Jan. 19, 2022, which is hereby incorporated by reference in its entirety for all purposes.

### TECHNICAL FIELD

The present application relates to coating and composite materials for enhancing ballistic protection and armor systems with enhanced ballistic protection.

### BACKGROUND

The body armor industry currently employs ceramics, along with other materials, to defeat high-velocity projectiles fired from small arms weapons. For instance, Fejdyś et al. investigates the influence of ceramic properties on the ballistic performance of the hybrid ceramic-multi-layered UHMWPE composite armor (J Aust Ceram Soc 57, 149-161 (2021). https://doi.org/10.1007/s41779-020-00516-7).

U.S. Pat. No. 7,300,893 discloses the use of ceramics in the form of bulky rigid tiles or plates encapsulated in the elastomers to defeat these threats. The armor achieves its performance by first causing the softer jacket of the projectile to deform and fragment within the first few millimeters of the armor. The inner core of the projectile then interacts with the rest of the ceramic, causing a reduction in velocity. The projectile is then stopped by the ceramic or contained by additional ballistic backing material. However, the rigid nature of tiles/plates is not conducive to the complex geometry of ballistic head protection systems, and armors with ceramic tiles/plates are much heavier than those deployed for ballistic head protection systems.

WO 2016/018549 discloses an armor with a coating layer on the front surface of the armor. The coating layer is formed by adding metal or ceramic hollow spheres of 1-5 mm in diameter on a surface of the substrate, filling the interstitial spaces between the spheres with an uncured elastomeric polymer, and then allowing the elastomeric polymer to cure. However, it is difficult, to incorporate such a coating layer in the ballistic core stack and maintain uniformity of dispersion during the preforming and molding processes of a ballistic protection system. For instance, it is difficult to distribute and maintain the spheres uniformly across a surface, in particular, on curved surfaces.

Given the current state of the art, there remains a need for advanced ballistic materials, systems and methods that address the abovementioned issues.

The information disclosed in this Background section is provided for an understanding of the general background of the invention and is not an acknowledgement or suggestion that this information forms part of the prior art already known to a person skilled in the art.

### SUMMARY

In one aspect, the present disclosure provides a coating material for enhancing ballistic protection. The coating material includes a polymer binder, and particles of a material having a hardness of at least 10 GPa and mixed with the polymer binder. Particles have a nominal diameter less than 1 millimeter and are suspended in the coating material prior to application to a surface. In some embodiments, the polymer binder includes a non-elastomeric polymer binder. In some embodiments, the coating material further includes one or more additional or optional components such as a deflocculant, one or more water soluble organic solvents, alcohol and water.

The coating material can be applied to a surface of a substrate, whether it is planar or non-planar. The coating material can also be applied uniformly or non-uniformly across the surface when it is desired. The coating material can further be incorporated in the ballistic core stack of a ballistic protection article. The coating material enhances the performance of the article against high-velocity ballistic threats or the like, using the same or similar defeat principles as thick ceramic plates/tiles.

In another aspect, the present disclosure provides a composite material for ballistic protection. The composite material includes a substrate having a surface, and at least one layer of a coating material, such as those disclosed herein, applied on at least a portion of the surface of the substrate. In some embodiments, the composite material further includes a polymeric layer overlaying at least one layer of the coating material. Preferably, the polymeric layer, along with the substrate, encapsulates at least one layer of the coating material.

In yet another aspect, the present disclosure provides a method for producing a ballistic protection article. The method includes: (A) applying at least one layer of a coating material, such as those disclosed herein, on at least a portion of a surface of a substrate; (B) overlaying a polymeric layer on the at least one layer of the coating material, thereby producing a composite material; and (C) shaping the composite material into a predetermined shape. In some embodiments, the shaping (C) of the composite material into a predetermined shape includes: (C1) shaping the composite material into a pre-form shape; and (C2) shaping the composite material in the pre-form shape into the predetermined shape. In some embodiments, the method further includes (D) trimming the composite material in the predetermined shape into a final shape.

In still another aspect, the present disclosure provides an alternative method for producing a ballistic protection article. The method includes: (A) providing a first substrate and a second substrate; (B) applying at least one layer of a coating material on at least a portion of a surface of the first substrate, or on at least a portion of a surface of the second substrate, or both; (C) combining the coated first and second substrates to produce a composite material, wherein the at least one layer of the coating material applied on the first substrate and/or the at least one layer of the coating material applied on the second substrate are disposed between the first and second substrates; and (D) shaping the composite material into a predetermined shape. In some embodiments, each of the first and second substrates has been shaped in a pre-form shape prior to application of the at least one layer of the coating material.

The materials, systems and methods of the present disclosure have other features and advantages that will be apparent from, or are set forth in more detail in, the accompanying drawings, which are incorporated herein, and the following Detailed Description, which together serve to explain certain principles of exemplary embodiments of the present disclosure.

### BRIEF DESCRIPTION OF THE DRAWINGS

The accompanying drawings, which are incorporated into and constitute a part of this specification, illustrate one or more exemplary embodiments of the present disclosure and, together with the Detailed Description, serve to explain the principles and implementations of exemplary embodiments of the invention. The accompanying drawings are not necessarily to scale. The specific design features of the present invention as disclosed herein, including, for example, specific dimensions, orientations, locations, and shapes will be determined in part by the particular intended application and use environment. In addition, the components illustrated in the figures are combinable in any useful number and combination.

FIG. 1 is a cross-sectional view schematically illustrating an exemplary coating material in accordance with some embodiments of the present disclosure.

FIG. 2A is a cross-sectional view schematically illustrating an exemplary composite material in accordance with some embodiments of the present disclosure.

FIG. 2B is a cross-sectional view schematically illustrating another exemplary composite material in accordance with some embodiments of the present disclosure.

FIG. 2C is a cross-sectional view schematically illustrating another exemplary composite material in accordance with some embodiments of the present disclosure.

FIG. 2D is a cross-sectional view schematically illustrating another exemplary composite material in accordance with some embodiments of the present disclosure.

FIG. 2E is a cross-sectional view schematically illustrating another exemplary composite material in accordance with some embodiments of the present disclosure.

FIG. 2F is a cross-sectional view schematically illustrating another exemplary composite material in accordance with some embodiments of the present disclosure.

FIG. 2G is a cross-sectional view schematically illustrating another exemplary composite material in accordance with some embodiments of the present disclosure.

FIG. 3 illustrates a helmet having the coating material in accordance with an exemplary embodiment of the present disclosure.

FIG. 4 is a flowchart illustrating an exemplary method for producing a ballistic protection article in accordance with some embodiments of the present disclosure.

FIG. 5A is a photograph showing a panel after a coating material applied to an ultra-high molecular weight polyethylene (UHMWPE) substrate in accordance with some embodiments of the present disclosure.

FIG. 5B is a photograph showing a panel after a coating material dried on a UHMWPE substrate in accordance with some embodiments of the present disclosure.

FIG. 5C is a photograph showing a molded panel with a coating material encapsulated between UHMWPE plies in accordance with some embodiments of the present disclosure.

FIG. 6A is a photograph showing a fragmented round resulted from a ballistic test using a 48-ply panel with coating (Example 1) in accordance with some embodiments of the present disclosure.

FIG. 6B is a photograph showing an intact round resulted from a ballistic test using a 48-ply panel without coating (Comparative Example 2) in accordance with some embodiments of the present disclosure.

FIG. 7 is a flowchart illustrating another exemplary method for producing a ballistic protection article in accordance with some embodiments of the present disclosure.

### DETAILED DESCRIPTION

Reference will now be made in detail to implementation of exemplary embodiments of the present disclosure as illustrated in the accompanying drawings. The same reference indicators will be used throughout the drawings and the following detailed description to refer to the same or like parts. Those of ordinary skill in the art will understand that the following detailed description is illustrative only and is not intended to be in any way limiting. Other embodiments of the present disclosure will readily suggest themselves to such skilled persons having benefit of this disclosure.

In the interest of clarity, not all of the routine features of the implementations described herein are shown and described. It will be appreciated that, in the development of any such actual implementation, numerous implementation-specific decisions are made in order to achieve the developer's specific goals, such as compliance with application- and business-related constraints, and that these specific goals will vary from one implementation to another and from one developer to another. Moreover, it will be appreciated that such a development effort might be complex and time-consuming but would nevertheless be a routine undertaking of engineering for those of ordinary skill in the art having the benefit of this disclosure.

Many modifications and variations of the exemplary embodiments set forth in this disclosure can be made without departing from the spirit and scope of the exemplary embodiments, as will be apparent to those skilled in the art. The specific exemplary embodiments described herein are offered by way of example only, and the disclosure is to be limited only by the terms of the appended claims, along with the full scope of equivalents to which such claims are entitled.

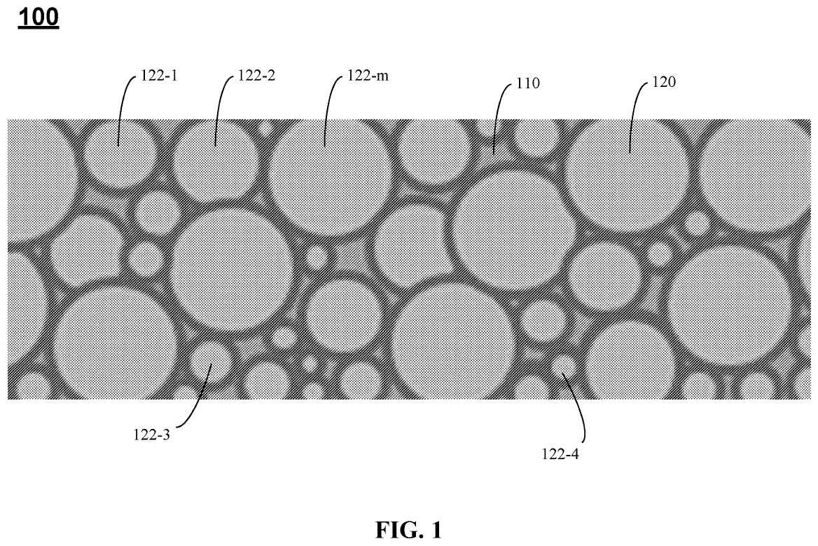

Referring now to FIG. 1, there is depicted an exemplary coating material 100 in accordance with some exemplary embodiments of the present disclosure. Coating material 100 generally includes a polymer binder 110 and ultrahard particles 120. In some exemplary embodiments, the polymer binder includes a non-elastomeric polymer binder. Examples of non-elastomeric polymer binder include, but are not limited to, polyetherimide (PEI), polyvinylpyrrolidone, polyepoxides or the like, or any combination thereof.

The ultrahard particles, as used herein, refer to particles having a hardness of at least 10 GPa, and in some cases, a hardness of at least 15 GPa, at least 20 GPa, at least 25 Gpa, at least 30 Gpa, at least 32 GPa, at least 34 GPa, or at least 36 GPa. A non-limiting example of an ultrahard particle is an ultrahard ceramic particle, such as boron carbide (B₄C) particles, boron nitride (BN) particles, silicon carbide (SiC) particles, aluminum oxide (Al₂O₃) particles, or the like. An ultrahard particles can be comprised of a single material or a combination of two or more different materials. For instance, in an embodiment, the ultrahard particles is one of B₄C particles, BN particles, SiC particles, and aluminum Al₂O₃. In another embodiment, the ultrahard particles is comprised of two or more of B₄C particles, BN particles, SiC particles, and aluminum Al₂O₃ particles. In still another embodiment, the ultrahard particles is comprised of at least one of B₄C particles, BN particles, SiC particles, and aluminum Al₂O₃ particles along with at least one additional and different particle.

In some embodiments, the ultrahard particles, e.g., particles 122-1, 122-2, 122-3, 122-4, . . . , 122-m, have a nominal diameter (e.g., mean or average outside diameter of the particles) less than 1 millimeter. In some embodiments, the nominal diameter of the particles is between about μm and about 500 μm, between about 1 μm and 250 μm, between about 1 μm and 100 μm, between about 0.1 μm and 1 μm, between about 0.1 μm and 5 μm, or between about 0.1 μm and 10 m. For instance, in an embodiment, the coating material includes B₄C ceramic particles having the nominal diameter between about 0.1 μm and 10 μm or between 1 μm and 20 μm.

The particles can have any suitable or desirable shapes, which can be either symmetric or asymmetric, either regular or irregular. Different particles can have substantially the same shape or different shapes (e.g., some particles may have a shape different than other particles). As a non-limiting example, FIG. 1 illustrates the particles, e.g., particles 122-1, 122-2, 122-3, 122-4, . . . , 122-m, having substantially the same spheric shape.

The particles can be solid, hollow, or porous with open-cell or closed-cell pore structures. For instance, in an embodiment, all of the particles are solid. In another embodiment, all of the particles are hollow. In still another embodiment, at least some of the particles are solid and at least some of the particles are hollow. In some embodiments, solid particles have a density of between about 1.0 g/cm³ and about 5.0 g/cm³, between about 1.5 g/cm³ and about 4.5 g/cm³, or between about 2.0 g/cm³ and about 4.0 g/cm³. Hollow particles have a density of between about 0.55 g/cm³ and about 0.95 g/cm³, between about 0.60 g/cm³ and about 0.90 g/cm³, or between about 0.65 g/cm³ and about 0.85 g/cm³.

Coating material 100 can include additional, optional or alternative components. For instance, in some embodiments, coating material 100 includes additional components such as a deflocculant, one or more water soluble organic solvents, alcohol, water, or the like, or any combination thereof. The deflocculant is included to reduce the viscosity of the coating material, prevent flocculation by increasing zeta potential and therefore the repulsive forces between particles, and/or minimize settling out of particles from the coating material. A nonlimiting example of a deflocculant is a sodium silicate deflocculant.

In some embodiments, the polymer binder (e.g., non-elastomeric polymer binder) is present in an amount of between about 1 wt % and about 7 wt %, between about 2 wt % and about 6 wt %, or between about 3 wt % and about 5 wt % of the total amount of the coating material. The particles are present in an amount of between about 20 wt % and about 65 wt %, between about 25 wt % and about 55 wt %, or between about 30 wt % and about 45 wt % of the total amount of the coating material. The deflocculant is present in an amount of between about 2 wt % and about 7 wt %, between about 2.5 wt % and about 6 wt %, or between about 3 wt % and about 5 wt % of the total amount of the coating material. The water is present in an amount of between about 10 wt % and about 45 wt %, between about 15 wt % and about 40 wt %, or between about 20 wt % and about 35 wt % of the total amount of the coating material. In some embodiments, the ratio of the polymer binder over the solid materials (e.g., particles, deflocculant) in the coating material is between about 1 wt % and about 35 wt %, between 5 wt % and 30 wt %, or between 10 wt % and 25 wt %.

In some embodiments, the polymer binder (e.g., non-elastomeric polymer binder) is present in an amount of between about 1 wt % and about 15 wt %, between about 2 wt % and about 6 wt %, or between about 3 wt % and about 5 wt % of the total amount of the coating material. The particles are present in an amount of between about 20 wt % and about 65 wt %, between about 25 wt % and about 55 wt %, or between about 30 wt % and about 45 wt % of the total amount of the coating material. The deflocculant is present in an amount of between about 0 wt % and about 7 wt %, between about 2 wt % and about 6 wt %, or between about 3 wt % and about 5 wt % of the total amount of the coating material. The water is present in an amount of between about 10 wt % and about 65 wt %, between about 15 wt % and about 60 wt %, or between about 20 wt % and about 55 wt % of the total amount of the coating material. In some embodiments, the ratio of the polymer binder over the solid materials (e.g., particles, deflocculant) in the coating material is between about 1 wt % and about 40 wt %, between 5 wt % and 35 wt %, or between 10 wt % and 30 wt %.

In some embodiments, the non-elastomeric polymer binder includes polyetherimide (PEI), the particles include B₄C ceramic particles, and the deflocculant includes a sodium silicate deflocculant. Preferably, The PEI has an average molecular weight of 25,000 g/mol, and the particles of the B₄C ceramic particles have the nominal diameter between about 1 μm and 20 μm. The non-elastomeric polymer binder is present in an amount of about 5 wt % to about 6 wt % wt %, the particles are present in an amount of about 50 wt % to 55 wt %, the deflocculant is present in an amount of about 4.5 wt % to about 5.5 wt %, and the water is present in an amount of about 30 wt % to about 40 wt % of the total amount of the coating material.

The polymer binder (e.g., non-elastomeric polymer binder) and ultrahard particles, along with other additional or optional components such as the deflocculant, water, water soluble organic solvents and/or alcohol are mixed such that particles are suspended in the coating material prior to application of the coating material to a surface or the like. That the particles are not necessarily of a specific shape allows optimization of particle shapes to desired performance. Moreover, incorporation of smaller particles (<1 mm) into the polymer binder allows for a more uniform distribution of particles in the coating material and enhances the ability to make a conformal coating with uniform thicknesses on curved surfaces. Further, the coating material allows for the application and processing of complex geometries such as those in producing an effective ballistic helmet. In addition, the coating material allows for non-uniform application with thicker layer or more layers of the coating material on desired areas.

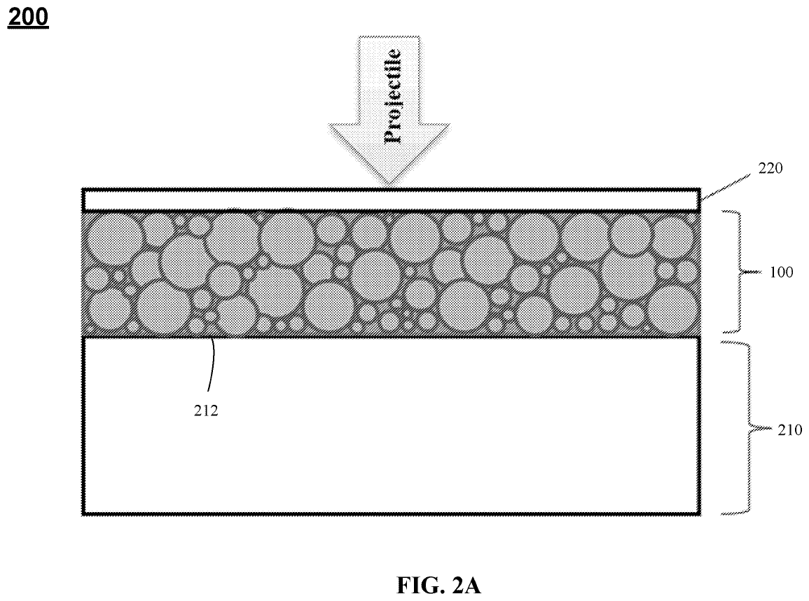

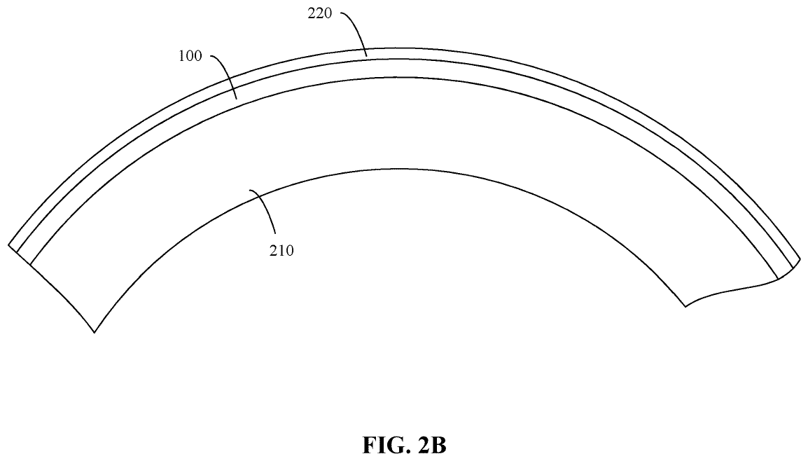

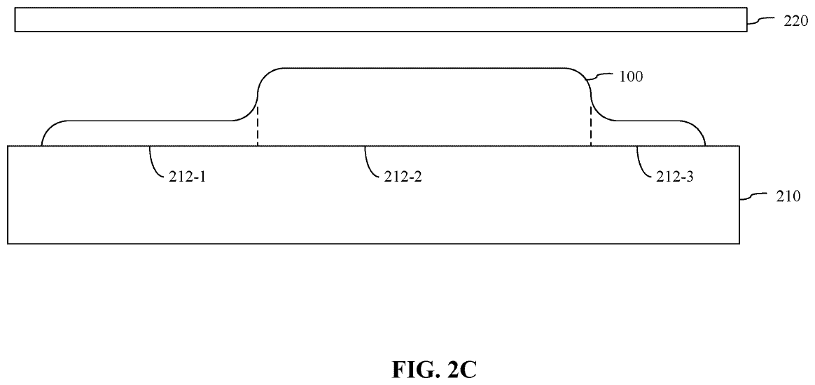

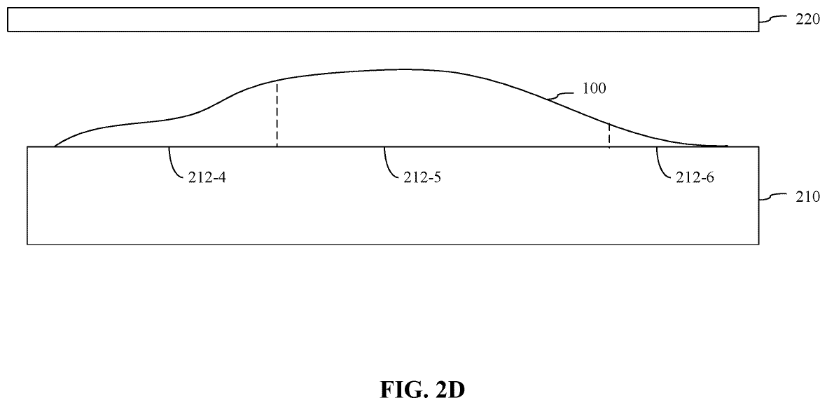

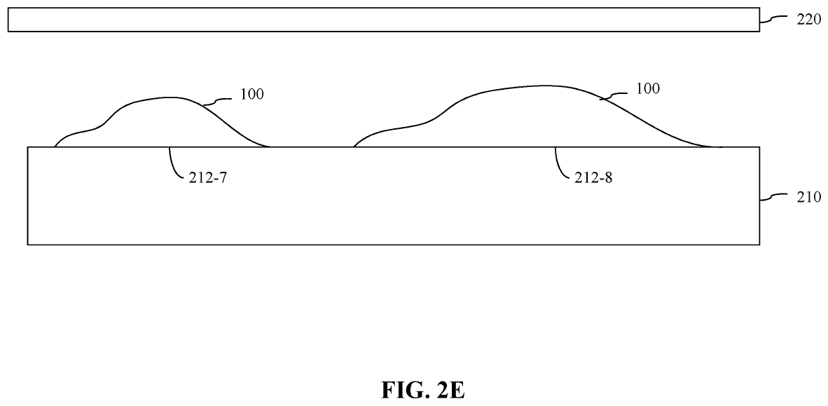

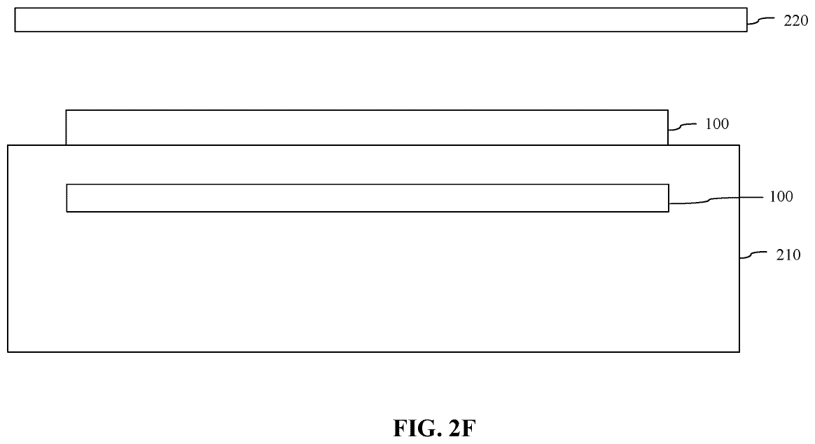

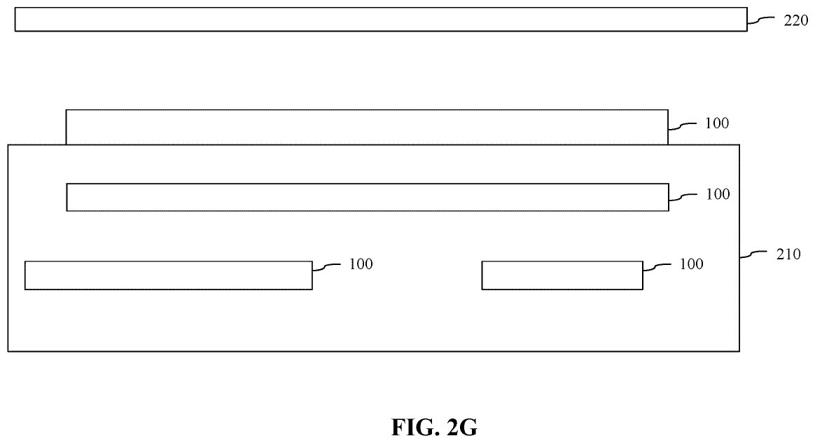

Referring to FIG. 2A, there is depicted an exemplary composite material 200 in accordance with some exemplary embodiments of the present disclosure. Composite material 200 generally includes a substrate 210 having a surface 212, and at least one layer of coating material 100 applied on at least a portion (e.g., at least 10%, at least 20%, . . . , or the entirety) of the surface of the substrate.

The substrate is generally made of a fiber/resin-based ballistic material. It can be rigid, flexible, or partly rigid and partly flexible. In some embodiments, the substrate or a portion of the substrate is made of a material including ultra-high molecular weight polyethylene (UHMWPE), poly-p-phenylene terephthalamide, aramid, or the like, or any combination thereof. The substrate can be of a single layer or a stack or layup of a composite structure including a plurality of layers/plies of one or more materials. For instance, in an embodiment, the substrate includes a single UHMWPE ply. In an embodiment, a single UHMWPE ply refers to a layer with 2, 3, 4 or more than 4 unidirectional plies tacked together orthogonally. In other embodiments, the substrate is a stack having between 2 and 10 layers/plies, between 10 and 30 layers/plies, between 30 and 100 layers/plies, or more than 100 layers/plies.

The substrate or the surface of the substrate can be planar or non-planar. For instance, as a non-limiting example, FIG. 2A a substantially planar substrate with a substantially planar surface. Typically, a substrate prior to a pre-forming process is substantially planar or flat. As another non-limiting example, FIG. 2B illustrates a non-planar substrate with a curved surface. In many cases, a substrate that has been subjected to a pre-forming process (e.g., consolidated and/or shaped in a pre-form shape) would have one or more non-planar parts or surfaces. While FIGS. 2A and 2B show two simple geometries, it should be noted that they are illustrative and non-limiting. The substrate can have much more complex geometries such as those in producing an effective ballistic helmet or the like.

The coating material can be applied to the substrate using a variety of methods, including but not limited to blade coating, spray coating, thermal spray coating, flow coating, spin coating, dip coating, grafting or via additive manufacturing methods including but not limited to ink jet printing, selective laser sintering, stereolithography, fused deposition modelling, fused filament fabrication, digital light synthesis and continuous liquid interphase production. In some embodiments, the coating material is applied to a substrate that has been consolidated/shaped into a pre-form shape, for instance, by painting, spraying, or the like. This allows the coating material to conform to more complex geometries and prevents the coating material from having to go through the pre-forming process.

The coating material can be applied on the surface of the substrate in a single layer or multiple layers (e.g., 2, 3, 4, 5, or more than 5 layers). In embodiments where multiple layers of the coating material are applied, each layer is dried before applying another layer of the coating material. Within the single layer or each of the multiple layers, the particles are distributed substantially uniformly across the portion of the surface to which the coating material is applied.

In some embodiments, the coating material is applied substantially uniformly (e.g., having the same number of layers or constant thickness) across at least a portion of the surface of the substrate. For instance, as a non-limiting example, FIG. 2A illustrates the coating material applied substantially uniformly across the entire surface 212 of the substrate. This produces a composite material that aims to provide equal protection for the desired area once it is made into a protection armor or system.

In some embodiments, the coating material is applied non-uniformly (e.g., having different number of layers or varied thickness) across at least a portion of the surface of the substrate. For instance, in embodiments where more protection is desired for one or more areas (e.g., areas corresponding to more important body parts or organs), a thicker layer or more layers of the coating material can be applied to one or more portions of the surface that correspond to the one or more areas when the composite material is made into a protection system.

As a non-limiting example, FIG. 2C illustrates at least one layer of the coating material is applied on portions 212-1, 212-2 and 212-3 of the surface of the substrate. The at least one layer of the coating material applied on portion 212-3 of the surface of the substrate has a thickness or a number of layers that is substantially the same as the at least one layer of the coating material applied on portion 212-1 of the surface of the substrate. The at least one layer of the coating material applied on portion 212-2 of the surface of the substrate has a thickness or a number of layers that is different (e.g., thicker or having more layers) than the at least one layer of the coating material applied on portion 212-1 of the surface of the substrate. When the composite material is made into a protection system, portion 221-2 of the surface of the substrate corresponds to an area where more protection is desired.

As another non-limiting example, FIG. 2D illustrates that the coating material is applied on portions 212-4, 212-5 and 212-5 of the surface of the substrate. The coating material has a varied thickness across portions 212-4, 212-5 and 212-6 of the surface of the substrate.

A thicker layer can be achieved, for instance, by applying the coating material to the desired portion multiple times (e.g., containing multiple layers). For instance, in embodiments illustrated in FIG. 2B, one or more layers of the coating material can be applied to portions 212-1, 212-2 and 212-3 of the surface of the substrate. After the one or more layers of the coating material are dried, an addition layer or layers of the coating material can be applied on top of the coating material at portion 212-2 to increase the number of layers or the thickness of the coating. Alternatively, a thicker layer can also be achieved, for instance, by spraying more coating material to the desired portion. For instance, more coating material can be applied on portion 212-2 than on portions 212-1 and 212-3 of the surface of the substrate, resulting in a thicker layer on portion 212-2 and a thinner layer on portions 212-1 and 212-3 of the surface of the substrate. Application of the coating material on different portions of the surface (e.g., portions 212-1, 212-2, and/or 212-3) can be concurrent or substantial.

In some embodiments, composite material 200 also includes an optional or additional polymeric layer 220 overlaying the at least one layer of the coating material. Preferably, the polymeric layer, along with the substrate, is configured and sized to encapsulate the at least one layer of the coating material. Polymeric layer 220 is generally made of a ballistic polymer and can include 1, 2, 3, 4, 5, more than 5 layers, or more than 10 layers. For instance, in an exemplary embodiment, the polymeric layer includes a single UHMWPE ply. In another embodiment, the polymeric layer includes 2, 3, 4, 5, or more than 5 UHMWPE plies.

In some embodiments, the coating material is applied on at least two spatially separated portions of the surface of the substrate. For instance, as a non-limiting example, FIG. 2E illustrates that the coating material is applied on two spatially separated portions, e.g., portions 212-7 and 212-8 of the surface of the substrate.

In some embodiments, the coating material is applied on a substrate that includes one or more layers of the coating material, e.g., a substrate that has already been applied with one or more layers of the coating material. As a non-limiting example, FIG. 2F illustrates application of the coating material to a substrate that has already been applied with one layer of the coating material. As another non-limiting example, FIG. 2G illustrates application of the coating material to a substrate that has already been applied with multiple layers of the coating material in the same or different regions of the substrate.

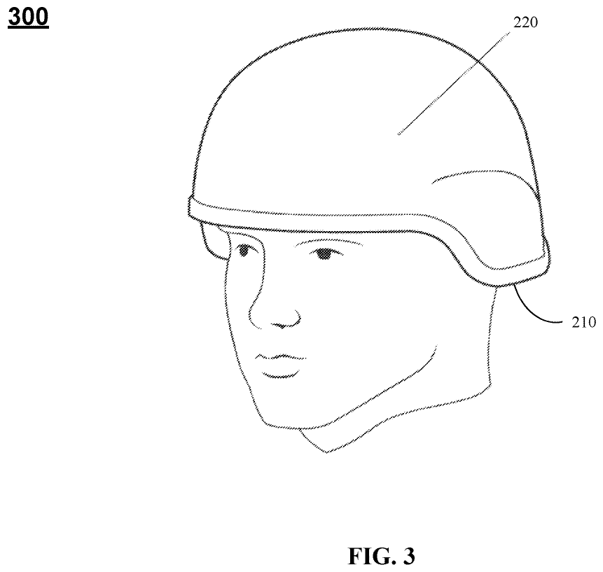

Composite material 200 can be used to create high-performance lightweight personal protective equipment. For instance, composite material 200 can be used to make personal protection articles such as body armors. As a non-limiting example, FIG. 3 illustrates a ballistic protection helmet 300 made of composite material 200.

Composite material 200 combines the benefits of multiple materials, such as the substrate (e.g., UHMWPE), the ultrahard particles (e.g., ceramics), the non-elastomeric polymer binder, and/or the polymeric layer, and enhances the performance of the article against high-velocity ballistic threats or the like. For instance, the coating material employs the same or similar defeat principles as thick ceramic plates/tiles, with the ultrahard ceramic in the coating material breaking-up or eroding the softer projectile upon impact. Moreover, the non-elastomeric polymer binder in the coating material enhances the stiffness of the ballistic core and ultimately the protection article. This will translate into superior blunt impact resistance of the protection article and improved crush strength performance. Further, the coating material can serve as a possible substitutional layer or layers of protection, and thus allow for the removal of fibrous ballistic material and reduces the overall part thickness without sacrificing ballistic performance.

In embodiments where the substrate includes UHMWPE, the UHMWPE possesses high strength and elongation properties necessary to absorb the energy of an incoming projectile. Integrating the particles within the UHMWPE gives the benefit of initially eroding the incoming projectile, allowing the UHMWPE to act upon a larger surface area by spreading the projectile's energy across a greater number of fibers. In addition to ballistic performance, the combination of ceramic and UHMWPE increase the resistance of a helmet system to denting and crushing when compared to a helmet manufactured using only UHMWPE.

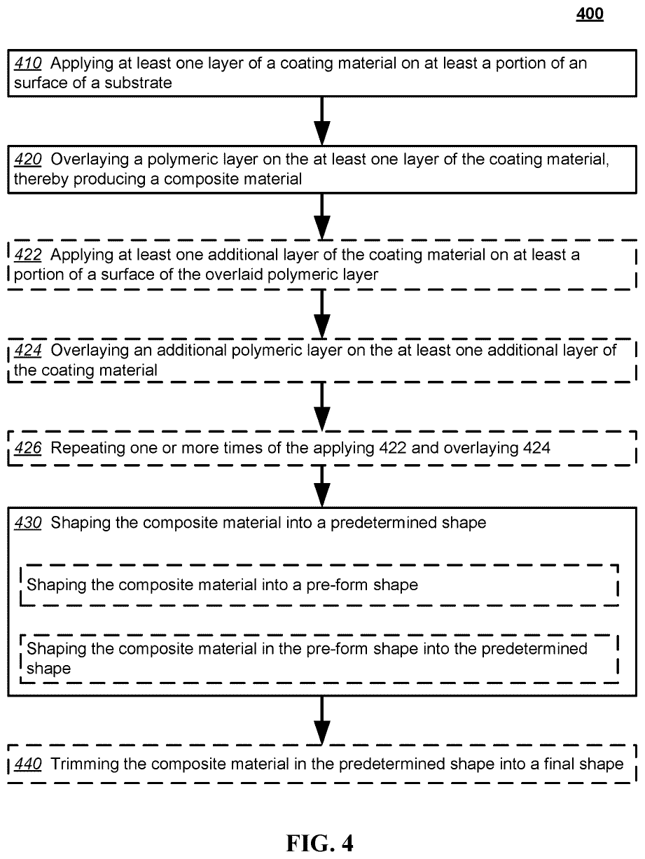

Referring to FIG. 4, there is depicted a flowchart illustrating an exemplary method 400 for producing a protection article in accordance with some embodiments of the present disclosure. In the flowchart, the preferred parts of the method are shown in solid line boxes, whereas additional, optional, or alterative parts of the method are shown in dashed line boxes. It should be noted that the processes disclosed herein and exemplified in the flowchart can be, but do not have to be, executed in full or in the order as they are presented.

Method 400 generally includes creating a composite material with a coating material and creating a protection article using the composite material. For instance, referring to block 410, in some embodiments, method 400 includes applying at least one layer of a coating material disclosed herein on at least a portion of a surface of a substrate (e.g., surface 212 of substrate 210). The substrate can be substantially planar (e.g., not in a pre-form shape) or non-planar (e.g., have been consolidated and/or shaped in a pre-form shape).

The at least one layer can be a single layer or multiple layers (e.g., 2, 3, 4, 5 or more than 5 layers). In embodiments where multiple layers of the coating material are applied, each layer is dried before applying another layer of the coating material. In some embodiments, the coating material is applied on at least 10%, at least 20%, . . . , or the entirety of the surface of the substrate. In an embodiment, the coating material is applied substantially uniformly (e.g., having the same number of layers or substantially the same thickness) across the portion or the entirety of the surface of the substrate. In an alternative embodiment, the coating material is applied non-uniformly (e.g., having different number of layers or varied thickness) across the portion or the entirety of the surface of the substrate.

Referring to block 420, in some embodiments, method 400 includes overlaying a polymeric layer (e.g., polymeric layer 220) on the at least one layer of the coating material, thereby producing a composite material. In some embodiments, the at least one layer of the coating material is covered by the polymeric layer. Preferably, the at least one layer of the coating material is encapsulated by the polymer layer and the substrate.

Referring to blocks 422, 424 and 426, in some embodiments, when desired, method 400 includes repeating one or more times the applying and overlaying steps as exemplified in blocks 410 and 420 on the overlaid polymeric layer to form a composite material that includes multiple layers (e.g., 2, 3, 4, 5 or more than 5 layers) of the coating material separated by a polymeric layer. For instance, as a non-limiting example, in some embodiments, method 400 includes: (i) applying a first layer of the coating material on at least a portion of a surface of a substrate, (ii) overlaying a first polymeric layer on the first layer of the coating material, (iii) applying a second layer of the coating material on at least a portion of a surface of the first polymeric layer, and (iv) overlaying a second polymeric layer on the second layer of the coating material, thereby forming a composite material with 2 layers of the coating material separated by the first polymeric layer. As another non-limiting example, in some embodiments, method 400 further includes (v) applying a third layer of the coating material on at least a portion of a surface of the second polymeric layer, and (vi) overlaying a third polymeric layer on the third layer of the coating material, thereby forming a composite material with 3 layers of the coating material separated by the first and second polymeric layers. The first, second and/or third layers of the coating material can have the same thickness or different thicknesses. Similarly, the first, second and/or third polymeric layers can have the same thickness or different thicknesses. In addition, the first, second and/or third polymeric layers can be made of the same material or different materials.

Referring to block 430, in some embodiments, method 400 includes shaping the composite material into a predetermined shape (e.g., a shape of a helmet). For instance, the composite material can be shaped into the predetermined shape by a method disclosed in U.S. Pat. No. 9,216,523 B2, the disclosure of which is incorporated herein for all purposes by reference in its entirety.

In some embodiments, such as those where the substrate has not been/shaped in a pre-form shape prior to application of the coating material, the shaping of the composite material into a predetermined shape is achieved by (a) shaping the composite material into a pre-form shape, referred herein as a pre-forming process, and (b) further shaping the composite material in the pre-form shape into the predetermined shape, referred herein as a final-forming process. In some embodiments, the pre-forming process is performed in the absence of added heat, and/or using a dynamic hydroforming process that employs a rigid, male-shaped tool and a non-rigid, female-shaped tool. The final-forming process is performed in the presence of added heat, and/or using at least one additional rigid forming tool.

In some embodiments, a substrate, e.g., a flat stack of the material comprised of different pattern shapes, is first created. The coating material is then applied to the substrate in a single layer or multiple, separate layers while the substrate is in the flat configuration. In some embodiments, an optional or additional polymeric layer is added overlaying the coating material. The coated substrate is then pre-formed to a pre-form or near-final shape. The order and geometry of the different pattern shapes play an important role in the pre-forming process. In some embodiments, the pre-forming process is achieved by applying high pressure to the stack while drawing over a tool with the intended shape. The stack in the pre-form shape is then molded into a blank. The molding process involves high pressure, typically above 13 MPa, and elevated temperatures, typically between 93° C. and 182° C. The blank is then trimmed into the final shape. In some embodiments, molding the combination of ballistic fiber, resin and coating materials occurs at a pressure between 13-34 MPa with the performance increasing as the pressure increases.

In some embodiments, such as those where the substrate has been shaped in a pre-form shape prior to application of the coating material, the composite material formed by application of a coating material to such a substrate is already in the pre-formed shape. As such, the pre-forming process may be skipped, and the consolidating and shaping of the composite material into a predetermined shape may be achieved by directly employing the final-forming process.

In some embodiments, method 400 includes one or more additional, optional or alternative processes. For instance, referring to block 440, in some embodiments, method 400 include trimming the composite material in the predetermined shape into a final shape. In some embodiments, method 400 includes pre-trimming the substrate, the coated substrate or the composite material, prior to the pre-forming process, into an appropriate planar shape corresponding to the non-planar shape of the desired pre-formed article. For example, if the desired pre-formed article has an approximately hemi-spherical shape, then the flat layers of the composite material may be pre-trimmed into circular shapes prior to the pre-forming process. Similarly, if the desired pre-formed article has an ovoid shape, then the flat layers of the composite material may be cut into the corresponding oval shape prior to the pre-forming process.

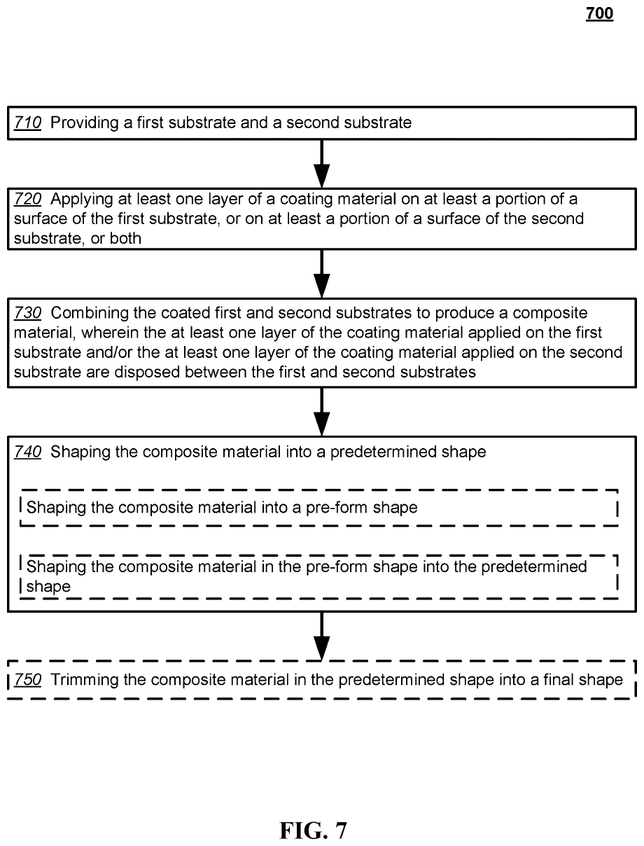

Referring to FIG. 7, there is depicted a flowchart illustrating an exemplary method 700 for producing a protection article in accordance with some embodiments of the present disclosure. In the flowchart, the preferred parts of the method are shown in solid line boxes, whereas additional, optional, or alterative parts of the method are shown in dashed line boxes. It should be noted that the processes disclosed herein and exemplified in the flowchart can be, but do not have to be, executed in full or in the order as they are presented.

Method 700 generally includes creating a composite material including two or more substrates and creating a protection article using the composite material. The two or more substrates can be but do not have to be in pre-formed shapes. A coating material disclosed herein is applied to at least one of the two or more substrates.

For instance, referring to block 710, in some embodiments, method 700 includes providing a first substrate and a second substrate. Each of the first and second substrates can be any one of the substrates (e.g., substrate 210) disclosed herein. Each of the first and second substrates can be substantially planar or in a pre-formed shape or in any other suitable shapes. Each of the first and second substrates can also include one or more layers of the coating material (e.g., one or more layers of the coating material have already been applied to the substrate). Generally, the first and second substrates are configured to mate with each other.

Referring to block 720, in some embodiments, method 700 includes applying at least one layer of a coating material disclosed herein on at least a portion of a surface of the first substrate, or on at least a portion of a surface of the second substrate, or both. The at least one layer can be a single layer or multiple layers (e.g., 2, 3, 4, 5 or more than 5 layers). In embodiments where multiple layers of the coating material are applied, each layer is dried before applying another layer of the coating material. In some embodiments, the coating material is applied on at least 10%, at least 20%, . . . , or the entirety of the surface of the first or second substrate. In an embodiment, the coating material is applied substantially uniformly (e.g., having the same number of layers or substantially the same thickness) across the portion or the entirety of the surface of the first or second substrate. In an alternative embodiment, the coating material is applied non-uniformly (e.g., having different number of layers or varied thickness) across the portion or the entirety of the surface of the first or second substrate.

Referring to block 730, in some embodiments, method 700 includes combining the coated first and second substrates to produce a composite material. Preferably, when the combined, the at least one layer of the coating material applied on the first substrate and/or the at least one layer of the coating material applied on the second substrate are disposed between the first and second substrates.

Referring to block 740, in some embodiments, method 700 includes shaping the composite material into a predetermined shape. In some embodiments, the shaping process of method 700 is the same or similar to the shaping process of method 400 disclosed herein.

Referring to block 750, in some embodiments, method 700 includes additional, optional or alternative processes such as trimming the composite material in the predetermined shape into a final shape. In some embodiments, the trimming process of method 700 is the same or similar to the trimming process of method 400 disclosed herein.

### Examples and Testing Results

Example 1. A coating material was constructed using 53.7 wt % of B4C particles with particles having a nominal diameter of 1 μm to 20 μm, 5.4 wt % of PEI having an average molecular weight of 25,000 g/mol, 5.1 wt % of sodium silicate deflocculant and 35.8 wt % of water. A planetary mixer was used to properly mix and distribute all ingredients. The liquid components were mixed first by spinning at 1500 RPMs for 30 seconds. The solid ingredients were then added and mixed for 120 second at 2,000 RPMs under a 25 kPa vacuum. After mixing, the coating material was cast overtop of a 150 mm×150 mm UHMWPE ply. The layer of the coating material was dried in an air-circulating oven at 37-49° C. for 5-10 minutes. The layer of the coating material has a thickness of about 0.76 mm.

The coated UHMWPE ply was combined with 47 plies of UHMWPE so that the layer of the coating material was located between the two outermost UHMWPE plies. This generated a composite material, referred herein as a panel, with the total number of 48 plies of UHMWPE. The panel was molded in a compression press with 17.3 MPa of pressure and at 138° C. for a total of 10 minutes. The panel was cooled to 21-20° C. before removing from the compression press.

That the coating material was placed between the two outermost plies of UHMWPE material enables the coating material to become consolidated and encapsulated within the stack of UHMWPE ballistic material during the molding process. Higher temperatures and pressures would aid in the consolidation properties of the ceramic material. However, the upper temperature limit in molding is defined by the polyethylene material and the pressure is limited by molding equipment.

Example 2. The coating composition and process are the same as in example 1, except the total number of UHMWPE plies of the panel is 35.

Example 3. The coating composition and process are the same as in example 1, except the total number of UHMWPE plies of the panel is 40.

Comparative Example 1. The panel is made of 60 UHMWPE plies. None of the UHMWPE plies are coated. The molding process of the panel is the same as in example 1.

Comparative Example 2. The panel is made of 48 UHMWPE plies. None of the UHMWPE plies are coated. The molding process of the panel is the same as in example 1.

Comparative Example 3. The panel is made of 35 UHMWPE plies. None of the UHMWPE plies are coated. The molding process of the panel is the same as in example 1.

Comparative Example 4: The panel is made of 40 UHMWPE plies. None of the UHMWPE plies are coated. The molding process of the panel is the same as in example 1.

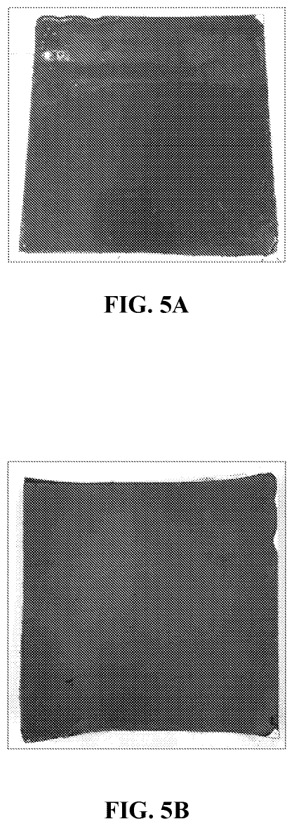

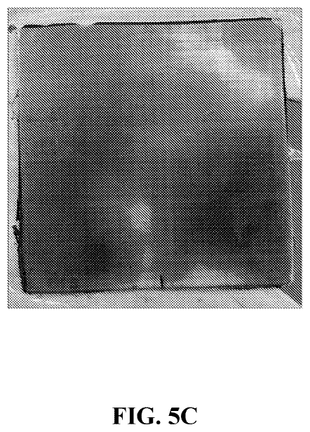

FIG. 5A shows a typical panel prior to drying), FIG. 5B shows a typical panel after drying and FIG. 5C shows a typical panel after molding. All of Examples 1-3 and Comparative Examples 1-4 were 150 mm×150 mm panels. Ballistic tests were performed on them against a relevant small arms projectile. The testing results are presented in Table 1 and Table 2, where “complete” indicates the projectile penetrated the panel completely, “partial” indicates the projectile penetrated the panel partially, and “BFD” stands for the back-face deformation from the ballistic event.

Table 1 shows the testing results of panels with various number of UHMWPE plies both with and without the coating. As shown, a panel with the coating (Example 1) had roughly the same BFD as a panel with 12 more plies of UHMWPE ballistic material without the coating (Comparative Example 1).

TABLE 1
Initial ballistic testing on coated and uncoated panels

| | | | | Total | | |
|---|---|---|---|---|---|---|
| | | | | Areal | | |
| | | Coating | Weight | Density | | BFD |
| Examples | # PE Ply | (Y/N) | (g) | (kg/m²) | Result | (mm) |
| Comparative | 60 | N | 165 | 7.13 | Partial | 35.5 |
| Example 1 | | | | | | |
| Comparative | 48 | N | 130 | 5.61 | Partial | 74.2 |
| Example 2 | | | | | | |
| Example 1 | 48 | Y | 161 | 6.93 | Partial | 38.3 |
| Comparative | 35 | N | 91 | 3.91 | Complete | — |
| Example 3 | | | | | | |
| Example 2 | 35 | Y | 121 | 5.22 | Complete | — |

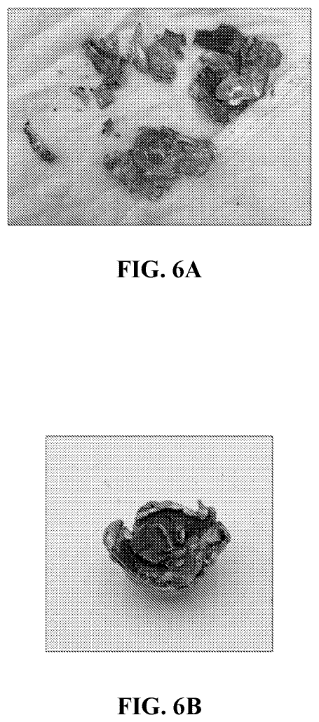

When looking at the same UHMWPE Ply count (48), the panel with the coating (Example 1) has a 48% reduction in BFD when compared to the panel without the coating (Comparative Example 2). Upon investigation of the stopped projectile, the deformation between the two tests were dissimilar. The panel with the coating (Example 1) had caused more erosion to the jacket and inner core of the projectile as shown in FIG. 6A than that without the coating (Comparative Example 2) as shown in FIG. 6B. The kinetic energy, which is about 4,500 Joules, was transmitted back into the round more effectively in the panel with the coating than the one without the coating as seen by the fragmented round in FIG. 6A and intact round in FIG. 6B. Without the coating, there was a greater transfer of energy directly to the UHMWPE in the panel, thereby resulting in greater BFD.

Table 2 shows testing results of panels with reduction of the UHMWPE ply count by 8 plies. As shown, the panel with the coating (Example 3 having a thickness of about 5.4 mm) shows improved results with only a partial penetration by the projectile over the panel without the coating (Comparative Example 4 having a thickness of about 4.6 mm) which allows for a complete penetration of the projectile. Furthermore, no BFD performance was lost at the reduced UHMWPE count (Example 3) when compared to the panel having more UHMWPE plies but no coating (Comparative Example 2 having a thickness of about 5.6 mm), demonstrating that the addition of the coating is aiding in maintaining BFD results. These results illustrate that with less plies of UHMWPE and having similar weight and areal density, ballistic performance is maintained but in a thinner profile.

TABLE 2
Additional ballistic testing with reduced PE ply count

| | | | | Total | | |
|---|---|---|---|---|---|---|
| | | | | Areal | | |
| | | Coating | Weight | Density | | BFD |
| Examples | # PE Ply | (Y/N) | (g) | (kg/m²) | Result | (mm) |
| Comparative | 48 | N | 130 | 5.61 | Partial | 74.2 |
| Example 2 | | | | | | |
| Comparative | 40 | N | 109 | 4.69 | Complete | — |
| Example 4 | | | | | | |
| Example 3 | 40 | Y | 134 | 5.76 | Partial | 79.2 |

### Terminologies and References Cited

The terminology used herein is for the purpose of describing particular implementations only and is not intended to be limiting of the claims. As used in the description of the implementations and the appended claims, the singular forms “a”, “an” and “the” are intended to include the plural forms as well, unless the context clearly indicates otherwise. It will be understood that the terms “left” or “right”, “top” or “bottom”, “lower” or “upper”, “interior” or “exterior”, and etc. are used to describe features of the exemplary embodiments with reference to the positions of such features as displayed in the figures. It will be understood that, although the terms “first,” “second,” etc. may be used herein to describe various elements, these elements should not be limited by these terms. These terms are only used to distinguish one element from another. For example, a first element could be termed a second element, and, similarly, a second element could be termed a first element, without changing the meaning of the description, so long as the “first element” and the “second element” are renamed consistently.

As used herein, the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “about” or “approximately” can mean within an acceptable error range for the particular value as determined by one of ordinary skill in the art, which can depend in part on how the value is measured or determined, e.g., the limitations of the measurement system. For example, “about” can mean within 1 or more than 1 standard deviation, per the practice in the art. “About” can mean a range of ±20%, ±10%, ±5%, or ±1% of a given value. Where particular values are described in the application and claims, unless otherwise stated, the term “about” means within an acceptable error range for the particular value. The term “about” can have the meaning as commonly understood by one of ordinary skill in the art. The term “about” can refer to ±10%. The term “about” can refer to ±5%.

All references cited herein are incorporated herein by reference in their entirety and for all purposes to the same extent as if each individual publication or patent or patent application was specifically and individually indicated to be incorporated by reference in its entirety for all purposes.

1. A coating material for enhancing ballistic protection, the coating material comprising:
a polymer binder; and
particles having a hardness of at least 10 GPa and mixed with the polymer binder,
wherein the particles have a nominal diameter less than 1 millimeter and are suspended in the coating material prior to application to a surface.

2. The coating material of claim 1, wherein the polymer binder comprises a non-elastomeric polymer binder.

3. The coating material of claim 2, wherein the non-elastomeric polymer binder comprises polyetherimide (PEI), polyvinylpyrrolidone, polyepoxide or any combination thereof.

4. The coating material of claim 1, wherein the particles comprise ultrahard ceramic particles.

5. The coating material of claim 4, wherein the ultrahard ceramic particles comprises particles of boron carbide (B₄C), boron nitride (BN), silicon carbide (SiC), aluminum oxide (Al₂O₃), or any combination thereof.

6. (canceled)

7. The coating material of claim 1, wherein at least some of the particles are solid.

8. The coating material of claim 7, wherein the solid particles have a density of between about 1.0 g/cm³ and about 5.0 g/cm³, between about 1.5 g/cm³ and about 4.5 g/cm³, or between about 2.0 g/cm³ and about 4.0 g/cm³.

9. The coating material of claim 1, wherein at least some of the particles are hollow.

10. The coating material of claim 9, wherein the hollow particles have a density of between about 0.55 g/cm³ and about 0.95 g/cm³, between about 0.60 g/cm³ and about 0.90 g/cm³, or between about 0.65 g/cm³ and about 0.85 g/cm³.

11. The coating material of claim 1, wherein the nominal diameter of the particles is between about 1 μm and about 500 μm, between about 1 μm and 250 μm, between about 1 μm and 100 μm, between about 0.1 μm and about 50 μm, about 0.1 μm and about 10 μm, or between about 0.1 μm and 1 μm.

12. The coating material of claim 1 further comprising one or more components selected from the group consisting of:
a deflocculant;
one or more water soluble organic solvents;
alcohol; and
water.

13. The coating material of claim 12, wherein:
the polymer binder is present in an amount of between about 1 wt % and about 15 wt %, between about 2 wt % and about 6 wt %, or between about 3 wt % and about 5 wt %;
the particles are present in an amount of between about between about 20 wt % and about 65 wt %, between about 25 wt % and about 55 wt %, or between about 30 wt % and about 45 wt %;
the deflocculant is present in an amount of between about 0 wt % and about 7 wt %, between about 2 wt % and about 6 wt %, or between about 3 wt % and about 5 wt %; and
the water is present in an amount of between about 10 wt % and about 65 wt %, between about 15 wt % and about 60 wt %, or between about 20 wt % and about 55 wt %.

14. The coating material of claim 13, wherein:
the polymer binder is present in an amount of about 5 wt % to about 6 wt %;
the particles are present in an amount of about 50 wt % to 55 wt %;
the deflocculant is present in an amount of about 4.5 wt % to about 5.5 wt %; and
the water is present in an amount of about 30 wt % to about 40 wt %.

15. The coating material of claim 12, wherein:
the polymer binder comprises polyetherimide (PEI) with an average molecular weight of 25,000 g/mol;
the particles comprise B₄C ceramic particles, wherein the B₄C ceramic particles have the nominal diameter between about 1 μm and 20 μm; and
the deflocculant comprises a sodium silicate deflocculant.

16-59. (canceled)

60. A coating material for enhancing ballistic protection, the coating material comprising:
a non-elastomeric polymer binder; and
ultrahard ceramic particles having a hardness of at least 10 GPa and mixed with the non-elastomeric polymer binder,
wherein the ultrahard ceramic particles have a nominal diameter less than 1 millimeter and are suspended in the coating material prior to application to a surface,
wherein the non-elastomeric polymer binder comprises polyetherimide (PEI), polyvinylpyrrolidone, polyepoxide or any combination thereof, and
wherein the ultrahard ceramic particles comprises particles of boron carbide (B₄C), boron nitride (BN), silicon carbide (SiC), aluminum oxide (Al₂O₃), or any combination thereof.

61. The coating material of claim 1, wherein the particles have substantially the same spheric shape.

62. A helmet comprising a composite material for ballistic protection, the composite material comprising:
a substrate having a surface; and
at least one layer of the coating material of claim 1.

63. The helmet of claim 62, wherein the substrate is made of ultra-high molecular weight polyethylene (UHMWPE), poly-p-phenylene terephthalamide, aramid, or the like, or any combination thereof.

64. The helmet of claim 62, wherein the substrate includes a single ultra-high molecular weight polyethylene (UHMWPE) ply.

65. The helmet of claim 64, wherein the single UHMWPE ply is a layer with two, three, four or more than four unidirectional plies tacked together orthogonally.
